(19) United States
(12) Patent Application Publication
(10) Pub. No.: US 2018/0208825 A1
(43) Pub. Date: Jul. 26, 2018

(54) CONTROLLABLE SEALANT COMPOSITION FOR CONFORMANCE AND CONSOLIDATION APPLICATIONS

(71) Applicant: Halliburton Energy Services, Inc., Houston, TX (US)

(72) Inventors: Rajender Salla, Pune (IN); Shoy George Chittattukara, Thrissur (IN)

(73) Assignee: Halliburton Energy Services, Inc., Houston, TX (US)

(21) Appl. No.: 15/742,845

(22) PCT Filed: Aug. 10, 2015
(86) PCT No.: PCT/US2015/044419

§ 371 Date: Jan. 8, 2018

(51) Int. Cl. C09K 8/493; C09K 8/42; E21B 33/138; C04B 28/02

(52) U.S. Cl. CPC C09K 8/493; C09K 8/426; C04B 24/281; C04B 28/02; E21B 33/138

(57) ABSTRACT

Included are methods of using, systems including, and compositions for sealant compositions. Also included, are methods of using a sealant composition comprising introducing a sealant composition comprising a silane-based epoxy resin, polyethylenimine, and water into a subterranean formation.

### BACKGROUND

The present disclosure relates to treatment of subterranean formations and, in specific examples, to sealant compositions that may be used to reduce the flow of unwanted fluids and/or solids in a subterranean formation.

When hydrocarbons are produced from wells that penetrate hydrocarbon producing formations, unwanted fluids, e.g. water, may often accompany the hydrocarbons, particularly as the wells mature in time. The produced unwanted fluids, collectively referred to herein as “unwanted fluids,” can be the result of a fluid-bearing zone communicating with the hydrocarbon producing formations or zones by fractures, high permeability streaks, and the like; or the produced unwanted fluids may be caused by a variety of other occurrences which are well known to those skilled in the art, such as water coning, water cresting, bottom water, channeling at the wellbore, etc. As used herein, the term “zone” simply refers to a portion of the formation and does not imply a particular geological strata or composition. Over the life of such wells, the ratio of the unwanted fluid to hydrocarbons recovered may be undesirable in view of the cost of producing the unwanted fluids, separating them from the hydrocarbons, and disposing of them, which may result in a significant economic loss.

In soft formations or formations that have little or no natural cementation, sand and other fines, collectively referred to herein as “unwanted solids,” may be produced along with any hydrocarbons. Unwanted solid production can plug wells, erode equipment, and reduce well productivity. In certain producing regions, solids control completions are the dominant type and result in considerable added expense to operations. Over the life of such wells, the ratio of unwanted solids to hydrocarbons recovered may be undesirable in view of the cost of producing the unwanted solids, separating them from the hydrocarbons, and disposing of them, which may result in a significant economic loss.

A variety of techniques have been used to reduce the production of unwanted fluids. Generally, these techniques involve the placement of a material in a wellbore penetrating a fluid-bearing zone portion of a subterranean formation that may prevent or control the flow of the unwanted fluids into the wellbore. The techniques used to place these materials are referred to herein as “conformance techniques” or “conformance treatments.” Some techniques involve the injection of particulates, foams, gels, sealants, resin systems, or blocking polymers (e.g., cross-linked polymer compositions) into the subterranean formation so as to plug off the fluid-bearing zones. Similarly, a variety of treatments have been used to control unwanted solids. These treatments, referred to herein as “consolidation treatments,” typically involve chemically binding the unwanted solids particles that make up the formation matrix while simultaneously maintaining sufficient permeability to ensure desirable production rates. Both of the conformance and consolidation treatments may be expensive and the components used may be hazardous to personnel and the environment. Further, many conformance and consolidation treatments may be ineffective for use in treatment of subterranean formations comprising a clay content greater than 5%.

### BRIEF DESCRIPTION OF THE DRAWINGS

These drawings illustrate certain aspects of some of the embodiments of the present invention, and should not be used to limit or define the invention.

FIG. 1A is a schematic illustration of a polyethylenimine dendrimer.

FIG. 1B is a schematic illustration of a branched polyethylenimine.

FIG. 2 is a schematic illustration of an example fluid handling system for the preparation and delivery of a sealant composition into a wellbore.

FIG. 3 is a schematic illustration of example well system showing placement of a sealant composition into a wellbore.

### DETAILED DESCRIPTION

The present disclosure relates to treatment of subterranean formations and, in specific examples, to sealant compositions that may be used to reduce the flow of unwanted fluids and/or solids in a subterranean formation. The sealant compositions may comprise a silane-based epoxy resin, for example, (3-glycidoxypropyl) trimethoxysilane (“GPTMS”) in combination with a cross-linking polyethylenimine (“PEI”), for example, a polymer with a repeating unit composed of the amine group and a two carbon aliphatic CH₂CH₂ spacer. The sealant compositions may be used to reduce the flow of unwanted fluids and/or solids in a subterranean formation. Advantageously, the sealant compositions may be used to reduce costs, reduce environmental burden, and improve employee safety. Additionally, the sealant compositions may be used for treatment of subterranean formations comprising a clay content greater than 5%.

The sealant compositions may comprise silane-based epoxy resin. The silane functional groups of the silane-based epoxy resins allow the silane-based epoxy resins to form strong bonds with silica, sandstone, etc. Without limitation by theory, the silane-based epoxy resins may form a monolayer on the surface of a material, allowing it to bind to a material and to also bind other materials, thus coupling two materials together. Examples of the silane-based epoxy resins may include, but are not limited to (3-glycidoxypropyl) trimethoxysilane, (3-glycidoxypropyl) triethoxysilane, (5,6-epoxyhexyl) triethoxysilane, (3-glycidoxypropyl) methyldiethoxysilane, (3-glycidoxypropyl) methyldimethoxysilane, (3-glycidoxypropyl) dimethylethoxysilane, or a combination thereof. The silane-based epoxy resins are water-soluble and may in a wide variety of aqueous-based fluids and subterranean formations. The silane-based epoxy resins may be obtained from or derived from any suitable source. Without limitation, the silane-based epoxy resins may be used in any amount in the sealant compositions, including a range from about 0.1% to about 20% by weight of the sealant composition. For example, the silane-based epoxy resins may be included in the sealant compositions in an amount of about 0.1%, about 1%, about 5%, about 10%, about 15%, or about 20% by weight of the sealant composition. One of ordinary skill in the art, with the benefit of this disclosure, should be able to recognize an appropriate amount of silane-based epoxy resins to use for a particular application.

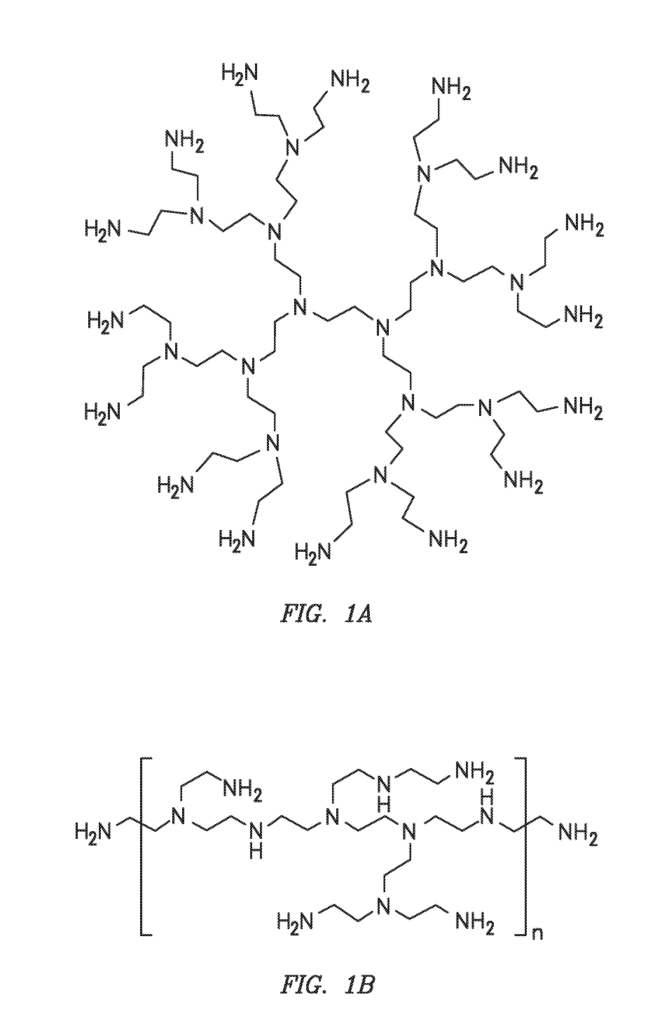

The sealant compositions may comprise PEI. PEI may function as a resin hardener and/or a cross-linker. Without limitation, the PEI may form a strong network of cross-linking within the silane-based epoxy resin monolayer. PEI may exhibit a high degree of cross-linking, because PEI has several amine functionalities which may be used for cross-linking. Thus, the degree of cross-linking while curing may be very high relative to cross-linkers comprising fewer amine functionalities. As a result, the cured sealant compositions may have many silane functionalities on the surface of the monolayer that are capable of providing binding to materials such as rock, sand, sandstone, cement, etc. The PEI is water-soluble and may in a wide variety of aqueous-based fluids and subterranean formations. In examples, dendrimer and branched PEI may be used, as the presence of tertiary amino groups is desirable. Linear PEI may only have secondary amino groups present and may therefore not cross-link in some examples to the degree that tertiary amino groups may. FIG. 1A is an example of a PEI dendrimer. FIG. 1B is an example of a branched PEI. The PEI may be obtained from or derived from any suitable source. Without limitation, the PEI may be used in any amount in the sealant compositions, including a range from about 0.01% to about 5% by weight of the sealant composition. For example, the PEI may be included in the sealant compositions in an amount of about 0.01%, about 0.1%, about 1%, about 2%, about 2.5%, or about 5% by weight of the sealant composition. One of ordinary skill in the art, with the benefit of this disclosure, should be able to recognize an appropriate amount of PEI to use for a particular application.

The concentration of the silane-based epoxy resin and/or the PEI as well as the ratio of the silane-based epoxy resin to the PEI may be adjusted to tailor the composition to a specific application. For example, adjustment of the concentrations and/or the ratio of the silane-based epoxy resin to the PEI may allow for modification of the permeability of a bound substrate, for example, fine sand or a section of the subterranean formation. As a specific example, a low concentration of both silane-based epoxy resin and PEI added to a gravel pack may reduce the permeability of the gravel pack, thereby reducing the amount of unwanted fluid and/or unwanted solids that may flow through the gravel pack. Alternatively, increasing the concentration of one or both of the silane-based epoxy resin and PEI and adding them to a same or similar gravel pack, may result in a complete loss of permeability within the gravel pack, thereby sealing the gravel pack and preventing flow through the gravel pack of both unwanted fluids and unwanted solids. In examples, the ratio of silane-based epoxy resin to PEI may be in a range of from about 20:1 to about 1:20, including every ratio in-between. For example, the ratio of silane-based epoxy resin to PEI may be about 15:1, about 12:1, about 10:1, about 7:3, about 5:2, about 1:1, about 2:5, about 3:7, about 1:10, about 1:12, about 1:15, and so on. As such, with the benefit of this disclosure, one of ordinary skill in the art should be able to adjust the concentration and ratio of the components to reduce permeability of a substrate to a desired level.

The sealant composition optionally may comprise an aqueous base fluid. Suitable aqueous base fluids may comprise, without limitation, freshwater, saltwater, brine, seawater, or any other suitable aqueous fluids that preferably do not undesirably interact with the other components used in the sealant composition. The amount of water included in the sealant composition may range, without limitation, from about 25% to about 99% by weight of the sealant composition.

The sealant compositions optionally may comprise any number of additional additives, including, but not limited to, salts, surfactants, acids, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, dispersants, flocculants, H₂S scavengers, CO₂ scavengers, oxygen scavengers, lubricants, viscosifiers, breakers, weighting agents, relative permeability modifiers, resins, particulate materials (e.g., proppant particulates), wetting agents, coating enhancement agents, and the like. A person skilled in the art, with the benefit of this disclosure, should recognize the types of additives that may be included in the sealant compositions for a particular application.

The sealant composition may be used in subterranean formations comprising a wide range of permeabilities. Without limitation, the sealant compositions may be used in subterranean formations comprising a permeability in a range including any of and between any of about 30 millidarcy (“mD”) to about 1300 mD. For example, the subterranean formation may comprise a permeability of about 30 mD, about 100 mD, about 200 mD, about 500 mD, about 750 mD, about 1000 mD, or about 1300 mD. One of ordinary skill in the art, with the benefit of this disclosure, should be able to recognize an appropriate subterranean formation in which to use the sealant compositions.

The sealant compositions may be used to reduce the permeability of a substrate. Substrate, as defined herein, is a material on to which the sealant composition binds. The sealant composition may reduce the permeability of the substrate in any desired amount. Without limitation, the sealant composition may reduce the permeability of the substrate in an amount in a range including about 1% to about 100%, where 100% represents a complete seal (e.g., 0 mD).

In conformance applications, the sealant compositions may form a barrier in the subterranean formation to block certain flow paths in the subterranean formation, reducing the flow of unwanted fluids through the subterranean formation, and in particular the flow of aqueous fluids. Examples of the types of flow paths that may be blocked by the barrier include, but are not limited to, perforations, such as those formed by a perforation gun, fissures, cracks, fractures, streaks, flow channels, voids, high permeable streaks, annular voids, or combinations thereof, as well as any other zone in the formation through which fluids may undesirably flow. Further, should a complete seal be desired, as defined by an area with a permeability of 0 mD, the sealant compositions may also be used to seal-off any gas flow if desired. The sealant compositions may be aqueous-based fluids and may be designed to have low viscosities in order to have high penetration. The sealant compositions should generally be stable at high temperatures and high pressures.

In consolidation applications, the sealant compositions may consolidate unwanted solids such sand and may even agglomerate other types of unwanted solids such as fines. Fines, as defined herein, are any type of unwanted solid particle that will not be removed by a shaker screen. The consolidation of unwanted solids, such as sand may be done to stabilize the subterranean formation and also so that the sand is not produced. Production of unwanted solids such as sand may damage well equipment and/or the subterranean formation. Conversely, fines may typically be produced so as to avoid near-wellbore damage. The agglomeration of the fines, should such agglomeration reach a sufficient level, may allow for the fines to not be produced in a manner similar to consolidated unwanted solids such as sand. Further, the agglomeration of the fines may allow for the fines that are produced to be filtered using shaker screens or any other sufficient filtration method, whereas non-agglomerated fines may not be removed via shaker screens.

In some consolidation applications, the system may be a single-step system. Advantageously, because the concentration of the silane-based epoxy resin and the PEI may be modified as desired, issues with pumping and in particular with modification of pump times, may be resolved through adjustment of the concentration/ratio of silane-based epoxy resin and/or PEI. Consolidation applications may not require post flush with solvents. Further, sealant composition may be designed to have a low viscosity which may increase penetration into a subterranean formation. The sealant composition may also be used in formations which comprise clay in a concentration greater than 5%.

As discussed above and as will be appreciated by those of ordinary skill in the art, the sealant compositions may be used in a variety of subterranean operations where it is desirable to reduce the flow of unwanted fluids and solids, such as conformance treatments, consolidation treatments, and lost circulation control amongst others. The sealant compositions may be used prior to, during, or subsequent to a variety of subterranean operations. Methods of using the sealant compositions may first include preparing the sealant compositions. The sealant compositions may be prepared in any suitable manner, for example, by combining the silane-based epoxy resin, PEI, and any of the additional components described herein in any suitable order. The sealant composition may be used as a single-step treatment in which the silane-based epoxy resin and PEI are mixed with the aqueous base fluid and then introduced into the subterranean formation for cross-linking. In some examples, it may be desirable to form the sealant composition immediately prior to use to prevent premature cross-linking before reaching the desired location in the subterranean formation. Alternatively, the sealant composition may be used as a multi-step treatment in which the silane-based epoxy resin and the PEI may be separately introduced into the subterranean formation for cross-linking. For example, the PEI may be placed into the subterranean formation where it may be contacted with the silane-based epoxy resin, which may already be present in the formation or subsequently introduced.

As discussed above, the silane-based epoxy resin and the PEI components of the sealant composition are also water soluble and as such, may be homogenously dispersed in a cement composition to form a cement resistant to fluid/gas/solid migration and/or to also form a cement having uniform strength development. The sealant compositions may be used with any of a variety of hydraulic cements suitable for use in subterranean cementing operations. Suitable examples include hydraulic cements that comprise calcium, aluminum, silicon, oxygen and/or sulfur, which set and harden by reaction with water. Examples of such hydraulic cements, include, but are not limited to, Portland cements, pozzolana cements, gypsum cements, high-alumina-content cements, slag cements, silica cements, and combinations thereof. Suitable Portland cements may be classified as Classes A, C, H, or G cements according to the American Petroleum Institute, API Specification for Materials and Testing for Well Cements, API Specification 10, Fifth Ed., Jul. 1, 1990. In addition, the hydraulic cement may include cements classified as ASTM Type I, II, or III. Therefore, as will be apparent to a person of ordinary skill in the art, with the benefit of this disclosure, the composition may also have use in cementing applications, where modification of cement permeability may be desirable.

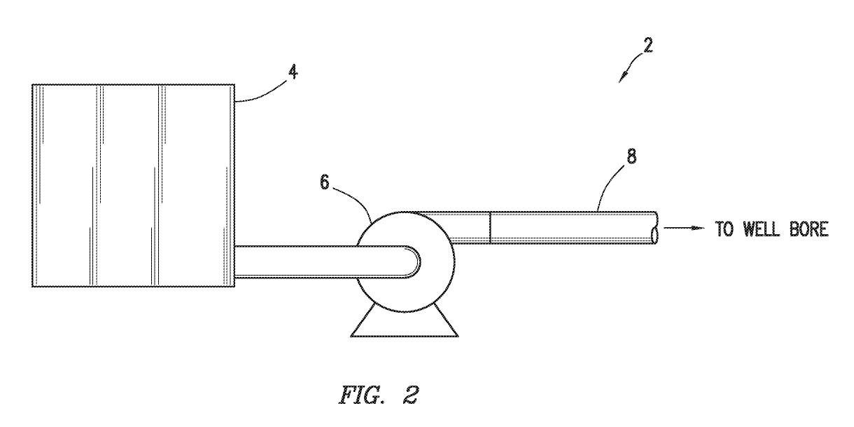

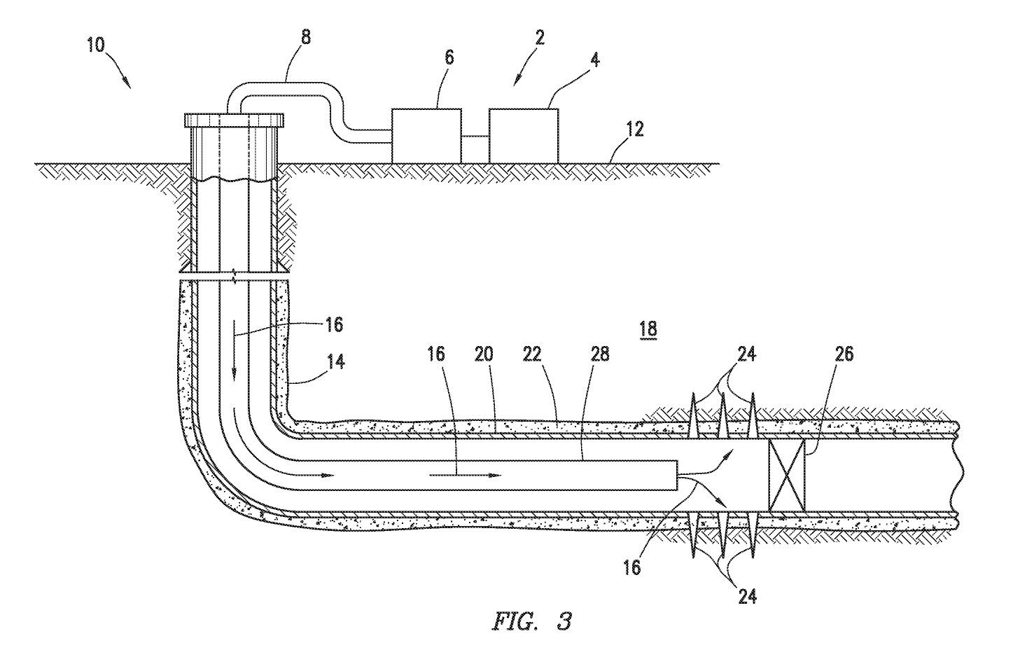

A method of using a sealant composition may be used in conjunction with one or more of the methods, compositions, and/or systems illustrated in FIGS. 2 and 3. The method may comprise introducing a sealant composition comprising a silane-based epoxy resin, polyethylenimine, and water into the subterranean formation. The method may further comprise pumping the sealant composition from a fluid supply and into a wellbore via a wellbore supply conduit fluidically coupled to the wellbore, the wellbore penetrating the subterranean formation. The silane-based epoxy resin may be present in the sealant composition in an amount of from about 0.1% to about 20% by weight of the sealant composition. The silane-based epoxy resin may comprise a silane-based epoxy resin selected from the group consisting of (3-glycidoxypropyl) trimethoxysilane, (3-glycidoxypropyl) triethoxysilane, (5,6-epoxyhexyl) triethoxysilane, (3-glycidoxypropyl) methyldiethoxysilane, (3-glycidoxypropyl methyldimethoxysilane, (3-glycidoxypropyl) dimethylethoxysilane, and a combination thereof. The polyethylenimine may be present in the sealant composition in an amount from about 0.01% to about 5% by weight of the sealant composition. The polyethylenimine may be a dendrimer. The polyethylenimine may be a branched polyethylenimine. The subterranean formation may comprise a permeability between about 30 mD and about 1300 mD prior to introduction of the sealant composition. The sealant composition may reduce the permeability of a portion of the subterranean formation in an amount between about 1% to about 100%. The sealant composition may reduce the flow of a fluid through a flow path selected from the group consisting of a perforation, a fissure, a crack, a fracture, a streak, a flow channel, a void, or a combination thereof. The subterranean formation may comprise clay in an amount greater than 5%. The sealant composition may be a component of a cement composition.

A sealant composition may be used in conjunction with one or more of the methods, compositions, and/or systems illustrated in FIGS. 2 and 3. The composition may comprise a silane-based epoxy resin, polyethylenimine, and water. The silane-based epoxy resin may be present in the sealant composition in an amount of from about 0.1% to about 20% by weight of the sealant composition. The silane-based epoxy resin may comprise a silane-based epoxy resin selected from the group consisting of (3-glycidoxypropyl) trimethoxysilane, (3-glycidoxypropyl) triethoxysilane, (5,6-epoxyhexyl) triethoxysilane, (3-glycidoxypropyl) methyldiethoxysilane, (3-glycidoxypropyl) methyldimethoxysilane, (3-glycidoxypropyl) dimethylethoxysilane, and a combination thereof. The polyethylenimine may be present in the sealant composition in an amount from about 0.01% to about 5% by weight of the sealant composition. The polyethylenimine may be a dendrimer. The polyethylenimine may be a branched polyethylenimine. The sealant composition may be a component of a cement composition.

A well system for using a sealant composition may be used in conjunction with one or more of the methods, compositions, and/or systems illustrated in FIGS. 2 and 3. The system may comprise a sealant composition comprising a silane-based epoxy resin, polyethylenimine, and water; a fluid handling system comprising the sealant composition; and a conduit fluidically coupled to the fluid handling system and a wellbore. The fluid handling system may comprise a fluid supply and pumping equipment. The silane-based epoxy resin may be present in the sealant composition in an amount of from about 0.1% to about 20% by weight of the sealant composition. The silane-based epoxy resin may comprise a silane-based epoxy resin selected from the group consisting of (3-glycidoxypropyl) trimethoxysilane, (3-glycidoxypropyl) triethoxysilane, (5,6-epoxyhexyl)triethoxysilane, (3-glycidoxypropyl) methyldiethoxysilane, (3-glycidoxypropyl) methyldimethoxysilane, (3-glycidoxypropyl) dimethylethoxysilane, and a combination thereof. The polyethylenimine may be present in the sealant composition in an amount from about 0.01% to about 5% by weight of the sealant composition. The polyethylenimine may be a dendrimer. The polyethylenimine may be a branched polyethylenimine. The sealant composition may be a component of a cement composition.

Example methods of using the sealant compositions will now be described in more detail with reference to FIGS. 2 and 3. Any of the previous examples of the sealant compositions may apply in the context of FIGS. 2 and 3. Referring now to FIG. 2, a fluid handling system 2 is illustrated. The fluid handling system 2 may be used for preparation of the sealant composition and for introduction of the sealant composition into a wellbore. The fluid handling system 2 may include mobile vehicles, immobile installations, skids, hoses, tubes, fluid tanks or reservoirs, pumps, valves, and/or other suitable structures and equipment. For example, the fluid handling system 2 may include a fluid supply 4 and pumping equipment 6, both of which may be fluidically coupled with a wellbore supply conduit 8. The fluid supply 4 may contain the sealant composition. The pumping equipment 6 may be used to supply the sealant composition from the fluid supply 4, which may include tank, reservoir, connections to external fluid supplies, and/or other suitable structures and equipment. While not illustrated, the fluid supply 4 may contain one or more components of the sealant composition in separate tanks or other containers that may be mixed at any desired time. Pumping equipment 6 may be fluidically coupled with the wellbore supply conduit 8 to communicate the sealant composition into the wellbore. Fluid handling system 2 may also include surface and down-hole sensors (not shown) to measure pressure, rate, temperature and/or other parameters of treatment. Fluid handling system 2 may include pump controls and/or other types of controls for starting, stopping, and/or otherwise controlling pumping as well as controls for selecting and/or otherwise controlling fluids pumped during the injection treatment. An injection control system may communicate with such equipment to monitor and control the injection treatment. Fluid handling system 2 can be configured as shown in FIG. 2 or in a different manner, and may include additional or different features as appropriate. Fluid handling system 2 may be deployed via skid equipment, marine vessel, or may be comprised of sub-sea deployed equipment.

Turning now to FIG. 3, an example well system 10 is shown. As illustrated, the well system 10 may include a fluid handling system 2, which may include fluid supply 4, pumping equipment 6, and wellbore supply conduit 8. As previously described in connection with FIG. 2, pumping equipment 6 may be fluidically coupled with the wellbore supply conduit 8 to communicate the sealant composition into wellbore 14. As depicted in FIG. 3, the fluid supply 4 and pumping equipment 6 may be above the surface 12 while the wellbore 14 is below the surface 12. Well system 10 may be configured as shown in FIG. 3 or in a different manner, and may include additional or different features as appropriate.

As illustrated on FIG. 3, the well system 10 may be used for introduction of a sealant composition 16, described herein, into subterranean formation 18 surrounding the wellbore 14. Generally, a wellbore 14 may include horizontal, vertical, slanted, curved, and other types of wellbore geometries and orientations, and the sealant composition 16 may generally be applied to subterranean formation 18 surrounding any portion of wellbore 14. As illustrated, the wellbore 14 may include a casing 20 that may be cemented (or otherwise secured) to wellbore wall by cement sheath 22. Perforations 24 can be formed in the casing 20 and cement sheath 22 to allow treatment fluids (e.g., sealant composition 16) and/or other materials to flow into and out of the subterranean formation 18. Perforations 24 can be formed using shape charges, a perforating gun, and/or other tools. A plug 26, which may be any type of plug (e.g., bridge plug, etc.) may be disposed in wellbore 14 below the perforations 24.

The sealant composition 16, which may comprise the silane-based epoxy resin and the PEI components, may be pumped from fluid supply 4 down the interior of casing 20 in wellbore 14. As illustrated, well conduit 28 (e.g., coiled tubing, drill pipe, etc.) may be disposed in casing 20 through which the sealant composition 16 may be pumped. The well conduit 28 may be the same or different than the wellbore supply conduit 8. For example, the well conduit 28 may be an extension of the wellbore supply conduit 8 into the wellbore 14 or may be tubing or other conduit that is coupled to the wellbore supply conduit 8. The sealant composition 16 may be allowed to flow down the interior of well conduit 28, exit the well conduit 28, and finally enter subterranean formation 18 surrounding wellbore 14 by way of perforations 24 through the casing 20 and cement sheath 22. The sealant composition 16 may undergo a cross-linking reaction in the subterranean formation 18 to form a gel network that blocks certain flow paths therein, reducing the flow of unwanted fluids and/or solids through the subterranean formation 18. In other examples, the sealant composition 16 may form a monolayer with strong bonds with a substrate (e.g., silica/sand stone) and may stabilize a portion of the subterranean formation 18 via consolidation. In still other examples, the sealant composition 16 may agglomerate fines, allowing for the produced agglomerated fines to be filtered via shaker screen or other suitable filtration method.

The exemplary sealant compositions disclosed herein may directly or indirectly affect one or more components or pieces of equipment associated with the preparation, delivery, recapture, recycling, reuse, and/or disposal of the sealant compositions. For example, the sealant compositions may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the sealant compositions. The sealant composition may also directly or indirectly affect any transport or delivery equipment used to convey the sealant composition to a well site or downhole such as, for example, any transport vessels, conduits, pipelines, trucks, tubulars, and/or pipes used to compositionally move the sealant composition from one location to another, any pumps, compressors, or motors (e.g., topside or downhole) used to drive the sealant composition into motion, any valves or related joints used to regulate the pressure or flow rate of the resin composition and spacer fluids (or fluids containing the same sealant composition, and any sensors (i.e., pressure and temperature), gauges, and/or combinations thereof, and the like. The disclosed sealant composition may also directly or indirectly affect the various downhole equipment and tools that may come into contact with the sealant compositions such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

### EXAMPLES

To facilitate a better understanding of the present embodiments, the following examples of some of the preferred embodiments are given. In no way should such examples be read to limit, or to define, the scope of the disclosure.

### Example 1

A sand pack was prepared using 50% silica flour (SSA-1™ Strength-Stabilizing Agent available from Halliburton Energy Services, Inc. of Houston, Tex.) and 50% 20/40 sand. This sand pack was used to represent formation materials. The initial permeability of the sand pack was measured by using a 3% KCl brine. Then a sealant composition using the 3% KCl brine as a base fluid was pumped subsequent. The concentrations of the components of the sealant composition are listed in Table 1 below. After a curing time of 3 days, the permeability was again measured using a 3% KCl brine.

After the final permeability test, the unconfined compressive strength (“UCS”) of the sand pack comprising the sealant composition was measured. The UCS may be measured using any sufficient means, for example, the Standard Test Method for Unconfined Compressive Strength of Cohesive Soil as described by ASTM D2166/D2166M. The results are shown in Table 1 below.

TABLE 1
Permeability Measurements

| | | Initial | Final | |
|---|---|---|---|---|
| Component | Concentration | Permeability | Permeability | UCS |
| GPTMS | 3% | 83 mD | 64 mD | 289 psi |
| PEI | 0.25% | | | |

The data illustrates that the sealant compositions may be used to selectively modify the permeability of a substrate, which in this example is a sand pack.

### Example 2

A sand pack was prepared in an analogous manner as to the sand pack used in Example 1. The initial permeability was tested, and then a sealant composition using the 3% KCl brine as a base fluid was pumped subsequent, just as was done in Example 1, except for Example 2, the concentrations of the components was tripled. The concentrations of the components of the sealant composition are listed in Table 2 below. After a curing time of 3 days, the permeability was again measured using a 3% KCl brine.

After the final permeability test, the unconfined compressive strength (“UCS”) of the sand pack comprising the sealant composition was measured. The results are shown in Table 2 below.

TABLE 2
Permeability Measurements

| | | Initial | Final | |
|---|---|---|---|---|
| Component | Concentration | Permeability | Permeability | UCS |
| GPTMS | 9% | 62 mD | 0 mD | 593 psi |
| PEI | 0.75% | | | |

The data illustrates that the sealant compositions may be used to completely seal the substrate, producing an impermeable sand pack.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method of using a sealant composition comprising:
introducing a sealant composition comprising a silane-based epoxy resin, polyethylenimine, and water into a subterranean formation.

2. The method of claim 1, further comprising pumping the sealant composition from a fluid supply and into a wellbore via a wellbore supply conduit fluidically coupled to the wellbore, the wellbore penetrating the subterranean formation.

3. The method of claim 1, wherein the silane-based epoxy resin is present in the sealant composition in an amount of from about 0.1% to about 20% by weight of the sealant composition.

4. The method of claim 1, wherein the silane-based epoxy resin comprises a silane-based epoxy resin selected from the group consisting of (3-glycidoxypropyl) trimethoxysilane, (3-glycidoxypropyl) triethoxysilane, (5,6-epoxyhexyl) triethoxysilane, (3-glycidoxypropyl) methyldiethoxysilane, (3-glycidoxypropyl) methyldimethoxysilane, (3-glycidoxypropyl) dimethylethoxysilane, and a combination thereof.

5. The method of claim 1, wherein the polyethylenimine is present in the sealant composition in an amount from about 0.01% to about 5% by weight of the sealant composition.

6. The method of claim 1, wherein the polyethylenimine is a dendrimer.

7. The method of claim 1, wherein the polyethylenimine is a branched polyethylenimine.

8. The method of claim 1, wherein the subterranean formation comprises a permeability between about 30 mD and about 1300 mD prior to introduction of the sealant composition.

9. The method of claim 1, wherein the sealant composition reduces the permeability of a portion of the subterranean formation in an amount between about 1% to about 100%.

10. The method of claim 1, wherein the sealant composition reduces the flow of a fluid through a flow path selected from the group consisting of a perforation, a fissure, a crack, a fracture, a streak, a flow channel, a void, or a combination thereof.

11. The method of claim 1, wherein the subterranean formation comprises clay in an amount greater than 5%.

12. The method of claim 1, wherein the sealant composition is a component of a cement composition.

13. A sealant composition comprising:
a silane-based epoxy resin,
polyethylenimine, and
water.

14. The composition of claim 13, wherein the silane-based epoxy resin is present in the sealant composition in an amount of from about 0.1% to about 20% by weight of the sealant composition.

15. The composition of claim 13, wherein the silane-based epoxy resin comprises a silane-based epoxy resin selected from the group consisting of (3-glycidoxypropyl) trimethoxysilane, (3-glycidoxypropyl) triethoxysilane, (5,6-epoxyhexyl) triethoxysilane, (3-glycidoxypropyl) methyldiethoxysilane, (3-glycidoxypropyl) methyldimethoxysilane, (3-glycidoxypropyl) dimethylethoxysilane, and a combination thereof.

16. The composition of claim 13, wherein the polyethylenimine is present in the sealant composition in an amount from about 0.01% to about 5% by weight of the sealant composition.

17. The composition of claim 13, wherein the polyethylenimine is a branched polyethylenimine.

18. A well system comprising:
a sealant composition comprising a silane-based epoxy resin, polyethylenimine, and water;
a fluid handling system comprising the sealant composition; and
a conduit fluidically coupled to the fluid handling system and a wellbore.

19. The well system of claim 18, wherein the fluid handling system comprises a fluid supply and pumping equipment.

20. The well system of claim 18, wherein the silane-based epoxy resin is present in the sealant composition in an amount of from about 0.1% to about 20% by weight of the sealant composition; and wherein the polyethylenimine is present in the sealant composition in an amount from about 0.01% to about 5% by weight of the sealant composition.
